(19) United States
(12) Patent Application Publication
(10) Pub. No.: US 2011/0055880 A1
(43) Pub. Date: Mar. 3, 2011

(54) PROVIDING VIRTUAL MARKETS FOR VIDEO PROGRAMS

(75) Inventor: Donald Gene Archer, Euless, TX (US)

(73) Assignee: VERIZON PATENT AND LICENSING, INC., Basking Ridge, NJ (US)

(21) Appl. No.: 12/548,845

(22) Filed: Aug. 27, 2009

(51) Int. Cl. H04N 7/173; G06F 3/00

(52) U.S. Cl. 725/87; 715/719

(57) ABSTRACT

A network device may receive a request for content from a device, identify a virtual market that is associated with the content by looking up a table entry associating the content with the virtual market, and transmit, to the device, the content and data for creating the virtual market within a memory of the device.

### BACKGROUND

By interacting with a set-top-box (STB), a user may select channels or programs on a television that is connected to the STB, adjust display characteristics of the television, and/or perform other interactive functions related to viewing multimedia content. A remote control may be used to transmit signals that represent key depressions/input selections to the STB via infrared light, for example.

### BRIEF DESCRIPTION OF THE DRAWINGS

FIG. 1 illustrates an exemplary embodiment of concepts described herein;

FIG. 2 is a block diagram of an exemplary network in which the concepts described herein may be implemented;

FIG. 3 is a block diagram of an exemplary device of FIG. 2;

FIG. 4 is a functional block diagram of an exemplary controller of FIG. 2;

FIG. 5 illustrates an exemplary virtual market;

FIG. 6 is a functional block diagram of an exemplary content storage device of FIG. 2;

FIG. 7 is a flowchart of an exemplary process associated with providing a virtual market via content-on-demand service; and

FIGS. 8 and 9 illustrate interacting with a virtual market provided via content-on-demand service.

### DETAILED DESCRIPTION

The following detailed description refers to the accompanying drawings. The same reference numbers in different drawings may identify the same or similar elements. As used herein, the term “virtual market” may refer to a software implementation and/or emulation of a market.

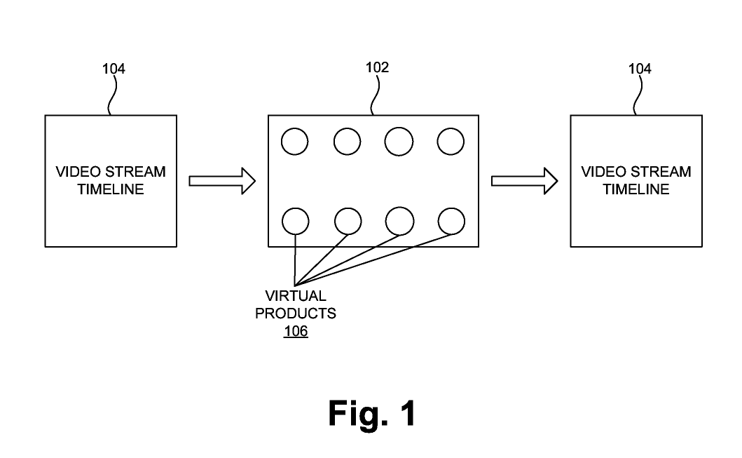

FIG. 1 illustrates the concepts described herein. Assume that a scheduled video program or a video-on-demand (VOD) video program is playing on a set-top box. A user is presented with a virtual 3-dimensional hallway 102 when a commercial would normally appear, as illustrated by the position of hallway 102 in video stream timeline 104. Using a remote control, the user must virtually walk through hallway 102 to resume the program.

Hallway 102 is populated with virtual products 106, analogous to “impulse-buy” products that line checkout aisles at a grocery store. The user can stop and examine a product, obtain specifications, and even purchase the product while the user is in hallway 102. Furthermore, the user may be allowed to “hang out” in hallway 106 for as long as the user likes. When the user decides to resume the video program, the user may simply walk to the end of virtual hallway 102 and return to the video program.

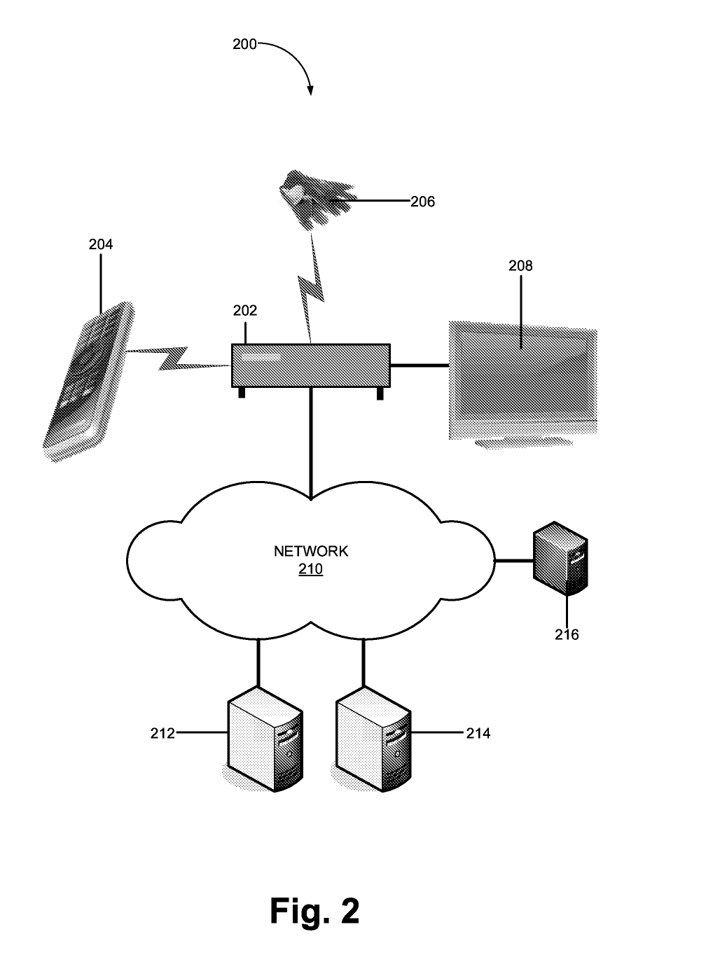

FIG. 2 is a block diagram of an exemplary network 200 in which the concepts described herein may be implemented. As shown, network 200 may include a controller 202 (e.g., a set-top box), remote control 204, sensory feedback device 206 (e.g., tactile feedback gloves or socks), content presentation device 208 (e.g., a television, stereo system, etc.), network 210, content server device 212, content storage device 214, and provisioning system 216. In other implementations, network 200 may include additional, fewer, or different devices, or a different arrangement of the devices. For example, network 200 may include a content distribution system (e.g., a video/audio broadcast system), additional provisioning systems, controllers, etc. Moreover, one or more devices of network 200 may perform one or more functions of another device of network 200. For example, controller 202 and content presentation device 208 may be implemented as a single device. In another example, data or information stored on content storage device 214 may be stored on multiple devices.

Controller 202 may include a device for receiving commands from remote control 204, receiving content over network 210, and/or playing the content on content presentation device 208. In some implementations, the content may be obtained from a content distribution system (e.g., a video/audio broadcast system) (not shown) via content-on-demand service.

In addition to playing content on content presentation device 208, for example, controller 202 may display a virtual market to a user and/or interact with the user via the virtual market displayed on content presentation device 208. By using remote control 204 and/or sensory feedback device 206, the user may move about in the virtual market, view products, manipulate the products (e.g., grab an item in the virtual market), and/or purchase the products. In some implementations, when the user purchases an item, controller 202 may place an order at provisioning system 216 over network 210.

Examples of controller 202 may include a set-top box or a component (e.g., a cable card) that plugs-into a host device (e.g., a digital video recorder, a personal computer, a television, stereo system, etc.) and allows the host device to display multimedia content (e.g., contents on digital cable television channels). Although controller 202 can be implemented as different types of devices (e.g., a set-top-box, computer, digital video disk (DVD) player, cable card, etc.), in the following, controller 202 is described in terms of a set-top box.

Remote control 204 may include a device for issuing wireless commands to and for controlling electronic devices (e.g., a television, set-top box, stereo system, digital video disc (DVD) player, etc.). In one situation, remote control 204 may be used to switch channels or obtain content-on-demand (e.g., video-on-demand) programs. In different implementations, in place of remote control 204, other types of devices (e.g., a wireless keyboard, mouse, handheld device (e.g., cell phone), etc.) may be used to control the electronic devices.

Sensory feedback device 206 may include one or more devices (e.g., electronic garment) for communicating motor/sensory data between controller 202 and the user. For example, assume that sensory feedback device 206 is a pair of electronic gloves. When the user wears the electronic gloves, the electronic gloves may transmit relative coordinates of the user's fingers and/or hands to controller 202.

Depending on the locations of the user's fingers and/or hands, controller 202 may send data/instructions that indicate how much pressure, heat, and/or other type of tactile sensation to provide to the user's hands. For example, assume that the location of the user's hand corresponds to a virtual hand that is holding a virtual vase. In such an instance, based on the instruction/data from controller 202, the electronic glove may provide the user with a sensation of holding a vase. In another example, the user may apply force against pressure sensors attached to the electronic gloves. The electronic gloves may send data that describes the force to controller 202. Controller 202 may use the information to manipulate the virtual hands (e.g., have the virtual hands hold the virtual vase).

Content presentation device 208 may include a device for playing media signals and/or signals from controller 202. Examples of content presentation device 208 may include a television, one or more speakers and a display, a portable digital assistant (PDA) or a cell phone capable of displaying a received video, etc. In the following paragraphs, content presentation device 208 is described in terms of a television.

Network 210 may include a fiber-optics network (e.g., passive optical networks (PONS)), an ad hoc network, a local area network (LAN), a wide area network (WAN), a wireless LAN, a metropolitan area network (MAN), a cellular network, a public switched telephone network (PSTN), an intranet, the Internet, a satellite-based network, any other network, or a combination of networks. Devices (e.g., controller 202, content server device 214, etc.) that are shown in FIG. 2 may connect to network 210 via wireless or wired communication links. In addition, network 210 may allow any of devices 202-208 to communicate with any other device 202-208. In some embodiments, devices 202-208 may communicate with each other directly rather than through network 210.

Content server device 212 may include one or more devices for providing content and/or for providing data or program that describes a virtual market. The content, data, and/or program may be sent to controller 202 and/or content presentation device 208. For example, content server device 212 may provide video-on-demand (VOD), television programs, etc. to controller 202.

Content storage device 214 may include a database of units of content (e.g., a movie, a piece of music, a video clip, etc.). Based on a user request, content server device 212 may retrieve a particular unit of content from content storage device 214. In addition, content storage device 214 may also include programs and/or data that describe virtual markets. Content server device 212 may retrieve one or more virtual market programs or sets of virtual market data from content storage device 214 when controller 202 requests a specific video, either scheduled or on-demand video.

Provisioning system 216 may receive an order for a product/service from controller 202 and/or process the order. For example, provisioning system 216 may receive an order for a cellular phone, charge a credit card, and cause the phone to be shipped to an address. In some implementations, system 216 may provide a web interface to those who wish track order filling or problem resolution (e.g., product unavailability).

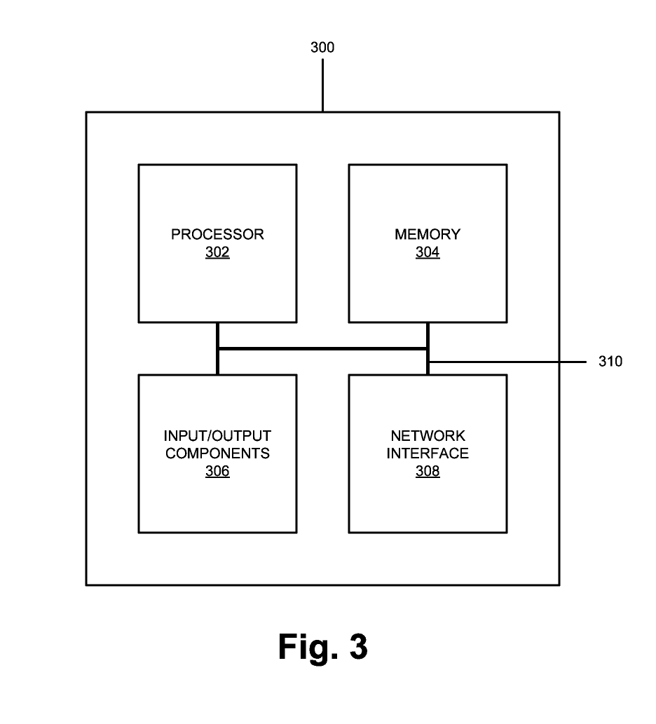

FIG. 3 is a block diagram of an exemplary network device 300, which may correspond to controller 202, content presentation device 208, content server device 212, content storage device 214, and/or a device in provisioning system 216. As shown, network device 300 may include a processor 302, a memory 304, input/output components 306, a network interface 308, and a communication path 310. In different implementations, network device 300 may include additional, fewer, or different components than the ones illustrated in FIG. 3. For example, network device 300 may include line interfaces, such as interfaces for receiving and forwarding data.

Processor 302 may include a processor, a microprocessor, an Application Specific Integrated Circuit (ASIC), a Field Programmable Gate Array (FPGA), and/or other processing logic capable of controlling network device 300. Memory 304 may include static memory, such as read only memory (ROM), and/or dynamic memory, such as random access memory (RAM), or onboard cache, for storing data and machine-readable instructions. Memory 304 may also include storage devices, such as a floppy disk, CD ROM, CD read/write (R/W) disc, and/or flash memory, as well as other types of storage devices.

Input/output components 306 may include a display screen, a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to network device 300.

Network interface 308 may include any transceiver-like mechanism that enables network device 300 to communicate with other devices and/or systems. For example, network interface 308 may include mechanisms for communicating via a network, such as the Internet, a terrestrial wireless network (e.g., a WLAN), a satellite-based network, etc. Additionally or alternatively, network interface 308 may include a modem, an Ethernet interface to a LAN, and/or an interface/connection for connecting network device 300 to other devices (e.g., a Bluetooth interface).

Communication path 310 may provide an interface through which components of network device 300 can communicate with one another.

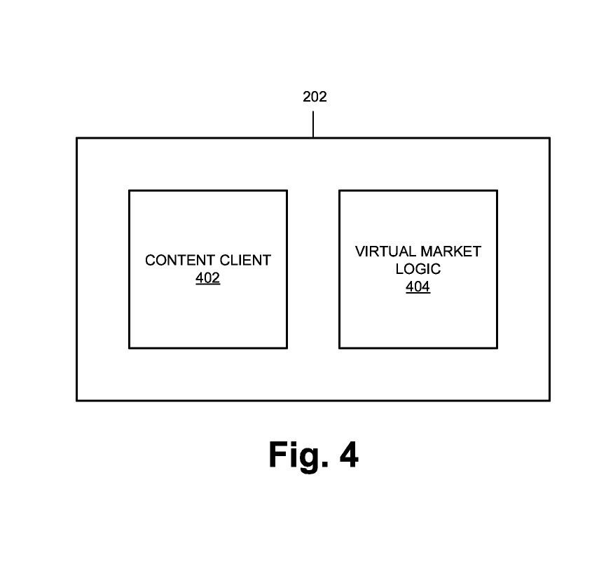

FIG. 4 is a functional block diagram of controller 202. As shown, controller 202 may include a content client 402 and virtual market logic 404. Depending on the implementation, controller 202 may include additional components, such as components illustrated in network device 300, an operating system (e.g., Linux, Windows, etc.), an application, etc. Furthermore, in some implementations, functionalities of content client 402 and/or virtual market logic 404 may be organized in a single component or more than two components.

Content client 402 may include hardware and/or software for outputting multimedia content/data that is received from a content distribution system (not shown), for example, to content presentation device 208. Content client 402 may receive audio/video data, and, based on the received audio/video data, may generate audio/video signals for content presentation device 208. Content client 402 may be implemented as a stand-alone application or as part of another component, such as a browser (not shown).

Virtual market logic 404 may include hardware and/or software for emulating a virtual market. In some implementations, virtual market logic 404 may be downloaded as a software component from content server device 212. In other implementations, virtual market logic 404 may be installed on controller 202 and may emulate different virtual markets based on data that controller 202 receives from content server device 212.

To emulate a virtual market, virtual market logic 404 may construct or represent a 3-dimensional model of the market in memory (e.g., memory 304). Virtual market logic 404 may display relatively continuous views of the virtual market as would be seen by a virtual user (e.g., a representation of the user in the virtual market) as the virtual user travels through the virtual market.

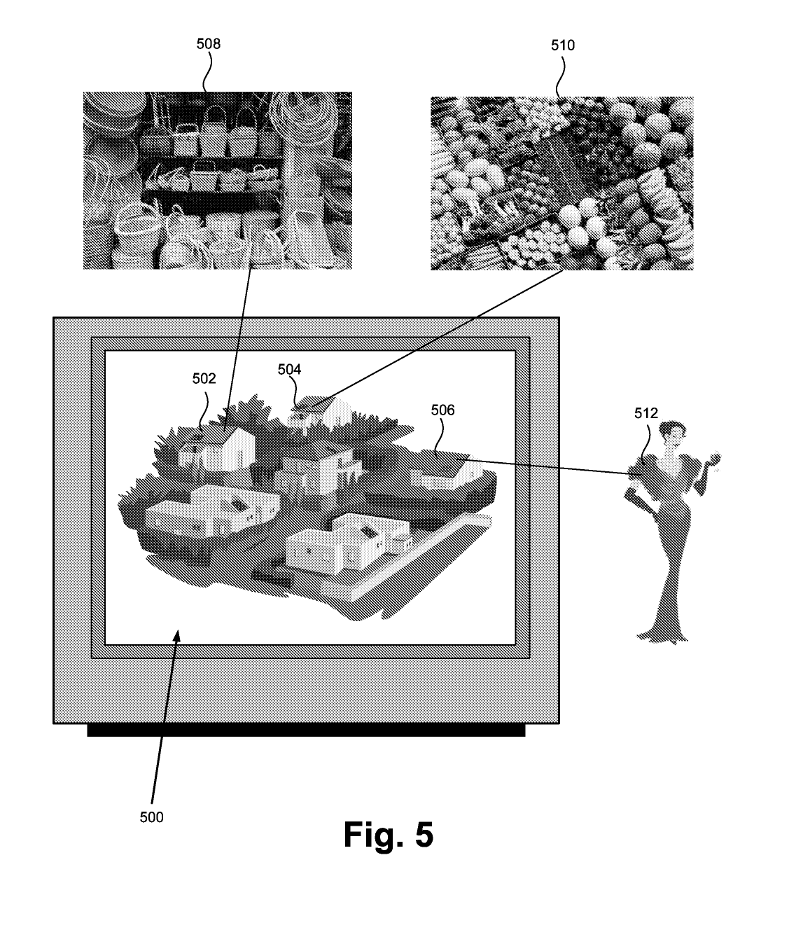

For example, assume that a virtual market is a portion of a town. In such a case, the market may include stores that line the streets of the town. Each store may include shelves, carts or boxes, tables, etc., that are stocked/filled with goods. FIG. 5 shows a view 500 of a virtual market that includes stores in a town. As shown, the virtual market may include a basket store 502, a produce store 504, and a clothing store 506. In different implementations, the virtual market (e.g., a mall, plaza, etc.) may include a different collection of stores.

Basket store 502, produce store 504, and clothing store 506 may include baskets 508, produce 510, and clothes 512 shown as being worn by a mannequin, respectively. As the user visits each store via a virtual user, the virtual user may interact with (e.g., touch, view, and/or manipulate) products/goods in the store. For example, when the user visits basket store 502, the user may pick up a virtual basket, view the virtual basket from different angles, open the virtual basket, view inside of the virtual basket, and/or initiate an on-line purchase of a basket that corresponds to the virtual basket. In another example, the user may pick up a virtual digital video disk (DVD) in a virtual movie rental store and play a preview/clip. In some implementations, the user may interact with the products/goods via sensory feedback device 206.

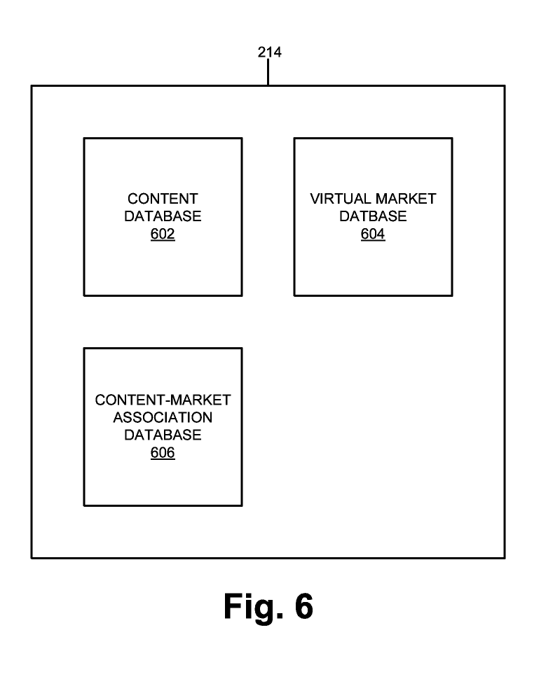

FIG. 6 is a functional block diagram of exemplary content storage device 214. As shown, content storage device 214 may include a content database 602 (e.g., database of movies, video clips, music, etc.), a virtual market database 604, and a content-market association database 606. Depending on the implementation, content storage device 214 may include additional, fewer, or different components than those shown in FIG. 6. In some implementations, components of content storage device 214 may be distributed over multiple network devices.

Content database 602 may include units of content, such as a movie, video clip, episode of television show, piece of commercial, song, audio clip, etc. Virtual market database 604 may include models of different types of virtual markets, such as a plaza, a building, a town, a single store, etc.

Content-market association database 606 may include table entries that associate each unit of content in content database 602 or a scheduled program with a particular virtual market in virtual market database 604. For example, assume that a James Bond movie is in content database 602, and a virtual gadget store that includes items shown in the James Bond movie is in a gadget market in virtual market database 604. In such an instance, content-market association database 606 may include an association between the James Bond movie and the gadget market. In some implementations, the table entries may include additional information, such as time when the user may enter the virtual market, a possible display locations at which the user can activate (e.g., via use of remote control) to enter the virtual market, etc., image or an icon that may be shown on the display location for activating the virtual market.

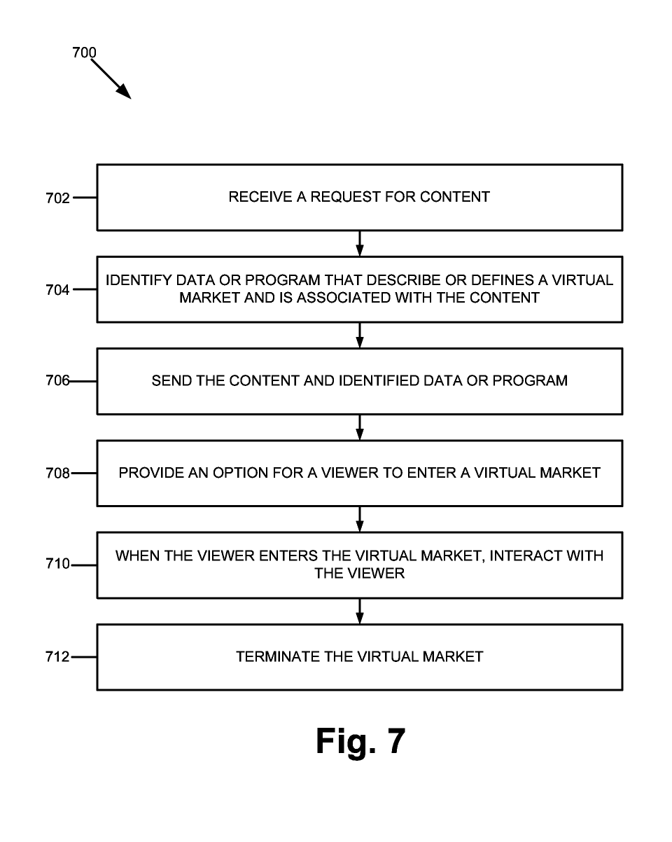

FIG. 7 is a flowchart of an exemplary process that is associated with providing a virtual market via a content-on-demand service. Assume that a user is viewing programs on content presentation device 208. In addition, assume that the user selects a unit of content (e.g., a movie) via remote control 204. Process 700 may start with content server device 212 receiving the selection of a unit of content (e.g., a scheduled program, VOD, etc.) from controller 202 over network 210 (block 702). Although not illustrated, the order may arrive at content server device 212 via typical network devices (e.g., routers, switches, etc.) in network 210. In response to the request, content server device 212 may provide the unit of content (e.g., from content database 602 in content storage device 214).

Depending on the implementation, content server device 212 or content storage device 214 may identify data or a program that describes or defines a virtual market associated with the unit of content (block 704). Herein, data may be said to “define” or “describe” a virtual market if a software program or device can use the data to create and emulate the virtual market. Similarly, a program may be said to “define” or “describe” a virtual market if the program, when executed, creates and/or emulates the virtual market.

Content server device 212 and/or content storage device 214 may identify the data/program by performing a search in content-market association database 606. In some implementations, more than one virtual market may be associated with the content, and, therefore, content server device 212/content storage device 214 may identify more than one set of data or programs.

Content server device 212 and/or content storage device 214 may send the unit of content and/or the identified data or programs to controller 202 (block 706). Depending on the implementation, content server device 212 and/or content storage device 214 may stagger the transmission of content and identified data/programs in time to avoid excessive delays in playing the content or to optimize the network bandwidth.

After controller 202 receives the content and/or the program, controller 202 may store (e.g., buffer) and/or play the content. While controller 202 is playing the content, e.g., when controller 202 reaches a point where a commercial is to be presented to the user, controller 202 may provide the user with an option to enter a virtual market (block 708). In a different implementation, controller 202 may present a view of the virtual market and provide the user with an option to exit the market. In one embodiment, the user must travel through the virtual market before resumption of the content.

When the user enters the market, controller 202 or content presentation device 208 may interact with the user (block 710). In interacting with the user, controller 202/content presentation device 208 may create a virtual market in memory (e.g., memory 304) based on the received data or program, and provide a view of the virtual market. The user may provide input to controller 202 or content presentation device 208 via remote control 204, sensory feedback device 206, and/or other types of input/output components 306. As described above, the user may roam about the market, visit a store, examine a virtual product, manipulate the virtual product, and/or purchase the product.

When the user indicates that the user wishes to exit the virtual market, controller 202/content presentation device 208 may terminate the presentation of the virtual market. If the user has been viewing/listening the content prior to interacting with the virtual market, controller 202 may start playing the content at the point where the user stopped viewing/listening.

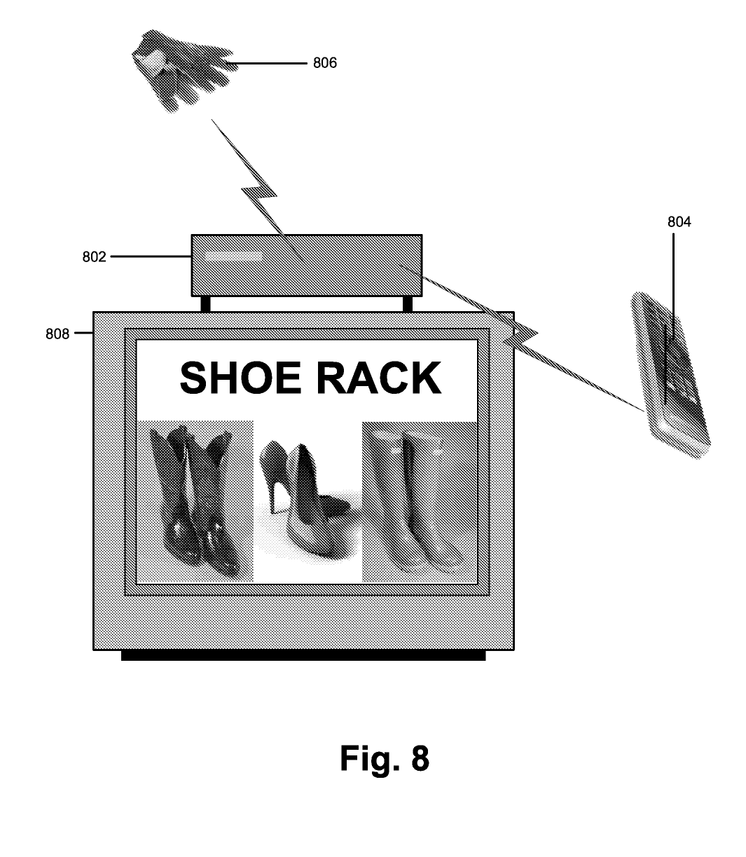

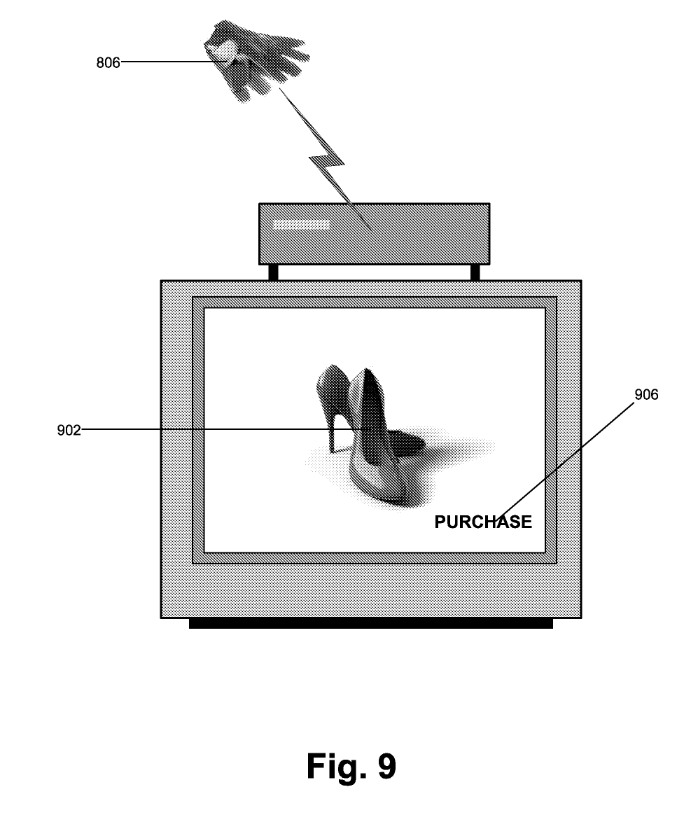

The above paragraphs describe system elements and processes that are related to devices and/or components for providing virtual markets. The following example, with reference to FIGS. 8 and 9 illustrates the processes for providing virtual markets. The example is consistent with exemplary process 700 described above with reference to FIG. 7.

In FIG. 8, assume a set-top box 802 (e.g., controller 202) is attached to a television 808 (e.g., content presentation device 208), that set-top-box 802 has downloaded data that defines a virtual market from content server device 212, that John (a user) has been watching The Valentine, a movie, via video-on-demand service, and that set-top box 802 has reached, while playing The Valentine, a point where a commercial can be shown to John. John uses remote control 804 and tactile feedback gloves 806 to provide input to set-top box 802.

Set-top box 802 displays, on television 808, a virtual hallway that is lined with stores and has a doorway at the end. Once placed inside the virtual hallway, John decides to shop for a Valentine's Day gift to Frances, his girlfriend, and, by using remote control 804 and enters a shoe store called Shoe Rack. Consequently, set-top box 802 shows a view of Shoe Rack. Inside the store, John notices a pair of virtual shoes that was shown in The Valentine. A couple of days prior, when John and Frances watched the movie together, Frances admired the shoes.

FIG. 9 shows the virtual shoes 902, as displayed on television 808. By using tactile feedback gloves 806, John “touches” virtual shoes 902, to verify that shoes 902 are made from material that Frances likes. In addition, John views shoes 902 from different angles, to be certain that shoes are of specific style.

John decides to purchase shoes 902, and, by using remote control 804, activates PURCHASE button 906. Set-top box 802 then shows John an on-line purchase order form. John orders the pair of shoes, and the order is processed by provisioning system 216. After John orders the shoes, set-top box 802 returns John to the virtual hallway. John exits the market via the door at the end of the virtual hallway, and set-top box 802 continues to play The Valentine.

A few days later, John receives a shipment of shoes. Frances is overjoyed to receive the shoes shown in The Valentine as a gift.

In the above example, a user may view and/or play a unit of content. During a timeslot for a commercial, for example, the user is presented with an opportunity to visit a virtual market. In the virtual market, the user may examine, manipulate, and/or purchase a specific product.

The foregoing description of implementations provides illustration, but is not intended to be exhaustive or to limit the implementations to the precise form disclosed. Modifications and variations are possible in light of the above teachings or may be acquired from practice of the teachings.

For example, in one implementation, in place of controller 202, a network server device, may emulate a virtual market. In such implementations, the user may interact with other virtual entities (e.g., a salesperson, other users, etc.) that are at the virtual market. In another implementation, at specified times while playing the content, an icon or an image may be shown on an area of the display to provide the user with an opportunity to activate the icon or the image. When the user activates the icon or the image, controller 202 may suspend playing the content and begin emulating the virtual market. In such an implementation, depending on the specific icon/image that the user activates, the user may be presented with a specific virtual market. For example, assume that the user activates an icon that is located just above James Bond's watch during in a scene of a Bond movie. Accordingly, controller 202 may begin emulating a watch store. In another example, the user may enter an actual store that is shown in the movie (e.g., a car dealer).

In addition, while series of blocks have been described with regard to an exemplary process illustrated in FIG. 7, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving a request for content from a device;
identifying a virtual market that is associated with the content by looking up a table entry associating the content with the virtual market; and
transmitting, to the device, the content and data for creating the virtual market within a memory of the device.

2. The method of claim 1, further comprising:
associating the virtual world, the content, and an amount of time for playing the content before the user is presented to the virtual market.

3. A method comprising:
receiving input that specifies content from a user;
sending a request for the content to a content server device;
receiving the content and data that includes information for creating a virtual market in a memory and emulating the virtual market;
emulating the virtual market;
receiving commands from the user for interacting in the virtual market; and
terminating the emulation of the virtual market.

4. The method of claim 3, wherein receiving input includes:
receiving, from a remote control, signals that select the content.

5. The method of claim 3, wherein receiving the content and data includes at least one of:
receiving the data from a content storage device; or
receiving the data from a content server device.

6. The method of claim 3, wherein sending a request includes:
requesting a video-on-demand service; or
changing a channel.

7. The method of claim 3, wherein emulating the virtual market includes:
creating a model of the virtual market in the memory; and
providing a view of the model to a user via a content presentation device.

8. The method of claim 3, wherein receiving commands includes:
receiving user input via at least one of a sensory feedback device, remote control, keyboard, mobile phone, or mouse.

9. The method of claim 3, wherein receiving commands includes at least one of:
receiving commands to manipulate virtual objects in the virtual market on behalf of the user;
receiving commands to provide views of the virtual market at different locations in the virtual market; or
receiving a command to purchasing a product in the virtual market.

10. The method of claim 9, wherein purchasing the product includes at least one of:
accepting an order for the product from the user; or
sending the order over a network to a provisioning system.

11. The method of claim 3, further comprising:
stopping the content from playing; and
resuming playing the content when the emulation of the virtual market terminates.

12. A system comprising:
a controller to:
receive user input that specifies a unit of content,
send a request for the unit of content over a network,
receive virtual market data that is associated with the unit of content over the network,
emulate a virtual market based on the virtual market data, and
play the unit of content; and
a network device to:
receive the request for the unit of content from the controller,
obtain the unit of content and the virtual market data from a storage device, and
send the unit of content and the virtual market data to the controller.

13. The system of claim 12, wherein the controller comprises:
a set-top box; a cable card; a computer; or a digital video disk (DVD) player.

14. The system of claim 12, wherein when the controller emulates a virtual market, the controller is configured to require the user to traverse the virtual market before resuming playing the content.

15. The system of claim 12, wherein the unit of content includes at least one of:
a movie, video clip, piece of music, or song.

16. The system of claim 12, wherein the virtual market comprises:
a virtual store including virtual products.

17. The system of claim 12, wherein the storage device includes at least one of:
videos, the virtual market data, or programs that describe virtual markets.

18. The system of claim 12, wherein the network includes:
a passive optical network (PON).

19. The system of claim 12, wherein the virtual market data includes:
a program that, when executed by the controller, creates the virtual market in a memory of the controller.

20. The system of claim 12, wherein the controller is further configured to:
purchase a product at a provisioning system over a network when a user orders a product via the virtual market.
